(19) United States
(12) Patent Application Publication
(10) Pub. No.: US 2015/0302353 A1
(43) Pub. Date: Oct. 22, 2015

(54) SERVICE SUPPORT APPARATUS

(71) Applicant: Focalworks Corporation, Tokyo (JP)

(72) Inventors: Sakaki MORISHITA, Tokyo (JP); Masafumi ENOMOTO, Tokyo (JP)

(73) Assignee: Focalworks Corporation

(21) Appl. No.: 14/662,219

(22) Filed: Mar. 18, 2015

Related U.S. Application Data
(60) Provisional application No. 61/982,346, filed on Apr. 22, 2014.

(51) Int. Cl. G06Q 10/10; G06Q 50/10

(52) U.S. Cl. CPC G06Q 10/101; G06Q 50/10

(57) ABSTRACT

When subscriber(s) have died, a service support apparatus assists in providing service(s) to service recipient(s) registered in advance by subscriber(s) in accordance with subscription content. Subscriber confirmation unit(s) of service support apparatus(es) notify subscriber(s) in the form of message(s) for confirmation of living status, and receive from subscriber(s) reply or replies indicating living status. In the event that there is no reply or replies from subscriber(s), alert unit(s) issue instruction(s) to inquire whether subscriber(s) are dead or alive with collaborator(s) registered in advance by subscriber(s). In the event that it is confirmed that subscriber(s) have died, service instruction unit(s) issue instruction(s) to provide service(s) to service recipient(s). The registration unit is constituted so as to accept registration of service recipient(s) and collaborator(s) by subscriber(s), at which time it is possible to register collaborator(s) by choosing from among service recipient(s).

### BACKGROUND OF THE INVENTION

1. Field of the Invention

The present invention pertains to data processing technology, and in particular pertains to an apparatus that will assist in the provision of services in connection with human deaths.

2. Description of the Related Art

The Great East Japan Earthquake, a calamity of unprecedented proportion, occurred in March of this year. Almost 20,000 human lives were lost in a tragedy which lasted but a brief instant. Most of us, unless we are advanced in years, ordinarily go about our daily lives unaware of death. It was an event that upset that lack of awareness at its very foundation.

How to deal with death when it comes suddenly and without warning? This is a problem requiring thought not only for oneself but also for the sake of the family one leaves behind as well as for others who will be affected. The more healthy and in the prime of one's working career one is the more there may be cause to wonder whether, despite having witnessed the threat that an earthquake represents, any thought has been given to this fact.

Of course, the arrangement known as life insurance exists. However, this is merely pecuniary compensation and does little to alleviate the mental anguish of those who survive the deceased. It has been reported that the first thing surviving family members look for upon returning to what remains of their homes in the desolated region left in the wake of an earthquake is photographs depicting deceased relatives. Money is no substitute for memories.

People often lament the fact that they were “unable to be there when so-and-so passed away.” Whether they were able to be there to hear the last words of the deceased is of great concern to those who survive the deceased. The last words of a dying individual encapsulate the relationship that the dying person has with the person who is the recipient of those words, and this being the case, can provide peaceful closure to the relationship that has existed between those two persons. Such a sense of completeness can make it possible for those who survive the deceased to endure their sadness until it gradually becomes something more gentle in the fullness of time.

The arrangement known as a last will and testament also exists (see Patent Reference No. 1 regarding electronic arrangements). However, wills ordinarily and in most cases have legal significance, being for the division of property or the like, and are ill-suited for imparting heartfelt words worthy of being listened to at the hour of death.

[Patent document 1] JP 2005-115406

### SUMMARY OF THE INVENTION

The present inventors became painfully aware of the need for especially healthy persons to have a mechanism to properly and routinely prepare for death, which may come to anyone suddenly and without warning. A mechanism that would, to the extent possible, alleviate the suffering of those who survive the deceased is also necessary. It is an object of the present invention to provide a system in which IT technology is utilized to achieve a totality and spiritual care that goes beyond life insurance and last wills and testaments.

In order to solve the aforesaid problem, a service support apparatus in accordance with one mode of the present invention is an apparatus that, when a subscriber has died, assists in providing a service to service recipients registered in advance by the subscriber in accordance with subscription content, the apparatus comprising a subscriber confirmation unit that notifies the subscriber in the form of a message for confirmation of living status, and that receives from the subscriber a reply indicating living status; an alert unit that, in the event that there is no reply from the subscriber, issues an instruction to inquire whether the subscriber is dead or alive with a collaborator registered in advance by the subscriber; an instruction unit that, in the event that it is confirmed that the subscriber has died, issues an instruction to provide the service; and a registration unit at which the service recipients and the collaborator are registered. The registration unit is constituted so as to permit the collaborator to be registered by choosing from among the service recipients.

Another mode of the present invention is also a service support apparatus. When a subscriber has died, this apparatus assists in providing a service to a prescribed service recipient in accordance with subscription content, the apparatus comprising a message receiving unit that receives, from the subscriber, a message created by the subscriber and addressed to the service recipient; a message providing unit that provides, to the service recipient, encrypted data obtained by encryption of the message; a decryption key providing unit that, in the event that it is confirmed that the subscriber has died, by providing, to the service recipient, a key for decryption of the encrypted data, makes it possible for the service recipient to access a decrypted message obtained by decryption of the encrypted data; and a confirmation data providing unit that provides, to the service recipient, data resulting from input of the message created by the subscriber into a one-way function so as to permit confirmation that the decrypted message obtained by decryption of the encrypted data has not been tampered with.

Note that any arbitrary combination of the respective elements indicated above, or expression of the present invention as a method, system, recording medium, or computer program, may also be effectively employed as a mode of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a drawing showing constitution of an ending services system;

FIG. 2 is a block diagram showing functional constitution of the service support apparatus at FIG. 1;

FIG. 3 is a drawing showing constitution of data stored at the service muster at FIG. 2;

FIG. 4 is a drawing showing constitution of data stored at the subscriber information storage unit at FIG. 2;

FIG. 5 is a drawing showing constitution of data stored at the service recipient information storage unit at FIG. 2;

FIG. 6 is a drawing showing constitution of data stored at the collaborator information storage unit at FIG. 2;

FIG. 7 is a drawing showing constitution of data stored at the document form muster at FIG. 2;

FIG. 8 is a drawing showing constitution of data stored at the message storage unit at FIG. 2;

FIG. 9 is a drawing showing constitution of data stored at the funeral plan muster at FIG. 2;

FIG. 10 is a drawing showing constitution of data stored at the funeral information storage unit at FIG. 2;

FIG. 11 is a drawing showing an example of an affected person registration page;

FIG. 12 is a block diagram showing detailed functional constitution of the will assistance unit at FIG. 2;

FIG. 13A is a drawing showing an example of a message creation page;

FIG. 13B is a drawing showing an example of a message creation page;

FIG. 13C is a d drawing showing an example of a message creation page;

FIG. 13D is a drawing showing an example of a message creation page;

FIG. 14 is a block diagram showing detailed functional constitution of the funeral assistance unit at FIG. 2;

FIG. 15 is a flowchart showing operations at service support apparatus;

FIG. 16 is a flowchart showing operations at service support apparatus;

FIG. 17 is a flowchart showing operations at service support apparatus;

FIG. 18 is a flowchart showing operations at service support apparatus; and

FIG. 19 is a flowchart showing operations at service support apparatus.

### DETAILED DESCRIPTION OF THE INVENTION

The invention will now be described by reference to the preferred embodiments. This does not intend to limit the scope of the present invention, but to exemplify the invention.

The present embodiment provides a service support apparatus which provides various services (hereinafter also referred to collectively as “ending service”) related to death(s) of person(s) to user(s). The person intended as the primary recipient of the services provided by this service support apparatus is a healthy person who can himself or herself make use of a computer terminal; in other words, a person currently in good health who believes himself or herself to be far from death. The service support apparatus assists the user by causing event(s) related to the user's own death to be designed in advance while the user is still healthy, so that following the death of the user the event(s) can be implemented in accordance with that design. A service support apparatus in accordance with the embodiment is primarily equipped with the following two technical elements.

Technical Element No. 1: Accurate determination of the fact that the user has died, and assistance in executing the ending services that were designated in advance by the user.

Technical Element No. 2: Making it possible for affected person(s) to confirm message(s) which the user has previously left for affected person(s), and making it possible for affected person(s) to confirm that message content has not been tampered with. Messages express things that the user wishes to convey to affected person(s), and may be digital data in the form of text, audio, image, video, or any suitable combination thereof.

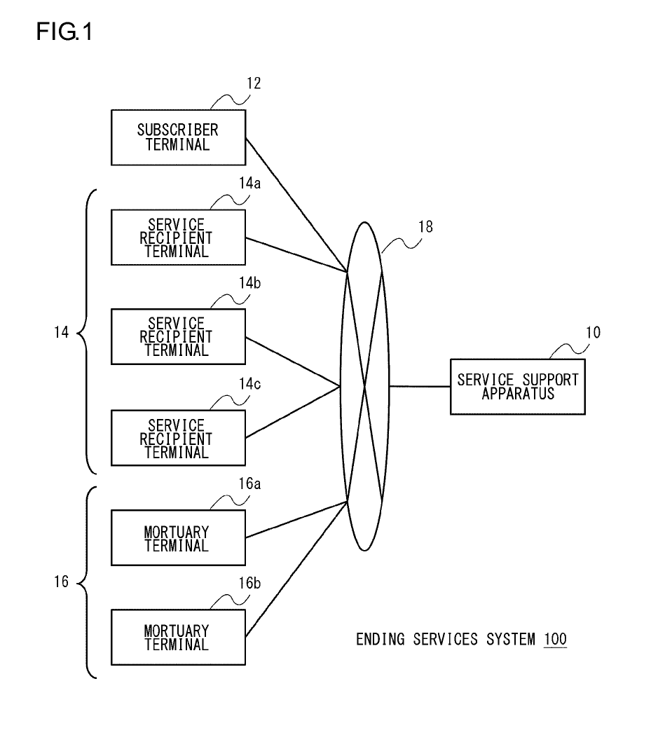

FIG. 1 shows the constitution of an ending services system. Ending services system 100 comprises service support apparatus(es) 10; subscriber terminal(s) 12; service recipient terminal(s) 14a, service recipient terminal(s) 14b, and service recipient terminal(s) 14c, which are collectively referred to as service recipient terminal(s) 14; and mortuary terminal(s) 16a and mortuary terminal(s) 16b, which are collectively referred to as mortuary terminal(s) 16. These respective apparatuses may be connected by way of communication network(s) 18 including LAN(s), WAN(s), the Internet, and so forth.

Service support apparatus 10 is equipped with the foregoing two technical elements, and is an information processing apparatus which is in the possession of an ending services provider (hereinafter also referred to as “service vendor”). Service support apparatus 10 has web server functionality, and causes web page(s) related to ending services to be provided to and displayed at subscriber terminal 12, service recipient terminal 14, and mortuary terminal 16.

Subscriber terminal 12, service recipient terminal 14, and mortuary terminal 16 are information processing terminals which have web client functionality, and may be stationary or may be portable. An example of the former might be a desktop PC; examples of the latter might be a mobile telephone, a smartphone, a tablet terminal, or the like in which a web browser is installed.

Subscriber terminal 12 is an information processing apparatus which is operated by a user (hereinafter referred to as a “subscriber”) who has subscribed with a service vendor for ending service(s) to be executed in the event of his or her own death. Service recipient terminal 14 is an information processing apparatus which is operated by a user (hereinafter referred to as a “service recipient”) designated by a subscriber as a person with respect to whom ending service(s) are to be provided. Mortuary terminal 16 is an information processing apparatus which is in the possession of a mortuary vendor working in collaboration with a service vendor.

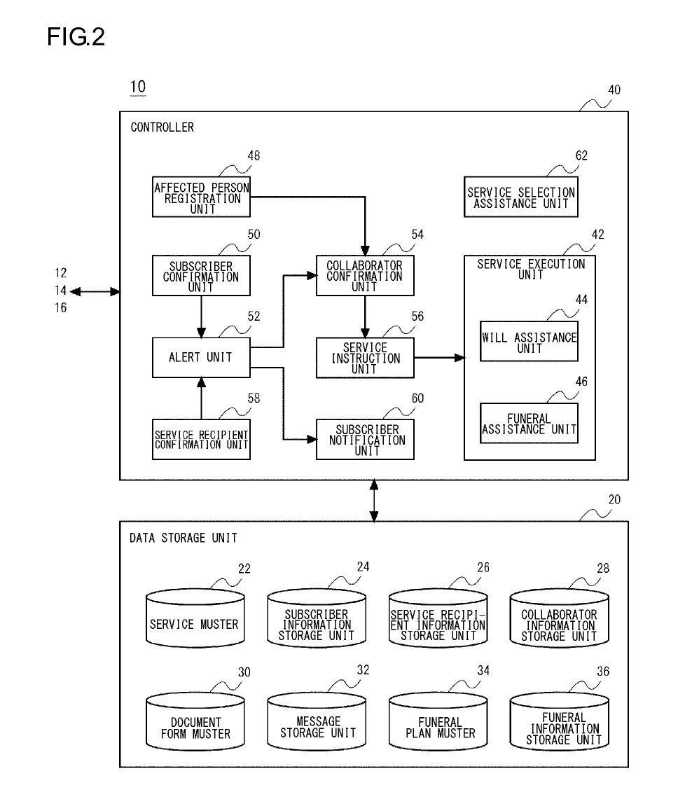

FIG. 2 is a block diagram showing the functional constitution of the service support apparatus 10 at FIG. 1. Service support apparatus 10 is equipped with data storage unit(s) 20 which are storage area(s) that store various types of data, and with controller(s) 40 which execute various types of data processing and/or communication processing. Note that because web server functionality is publicly known, description thereof is omitted below.

While the respective blocks shown in the block diagrams of the present specification may be implemented in hardware by means of elements and/or machine apparatuses including computer CPU(s), and may be implemented in software by means of computer program(s) or the like, the functional blocks envisioned here are implemented as a result of coordination therebetween. One of skill in the art will therefore understand that such functional blocks may be implemented in any of a wide variety of forms through combination of hardware and software. For example, data storage unit 20 in FIG. 2 may be implemented as main memory and/or storage at service support apparatus 10. Or controller 40 may be such that a computer program stored on a recording medium is installed within storage at service support apparatus 10. And when said program is launched, program modules corresponding to the respective functional blocks at controller 40 might be read into main memory of service support apparatus 10 and might be executed by a CPU to implement the respective functions of controller 40.

Data storage unit 20 comprises service muster 22, subscriber information storage unit 24, service recipient information storage unit 26, collaborator information storage unit 28, document form muster 30, message storage unit 32, funeral plan muster 34, and funeral information storage unit 36.

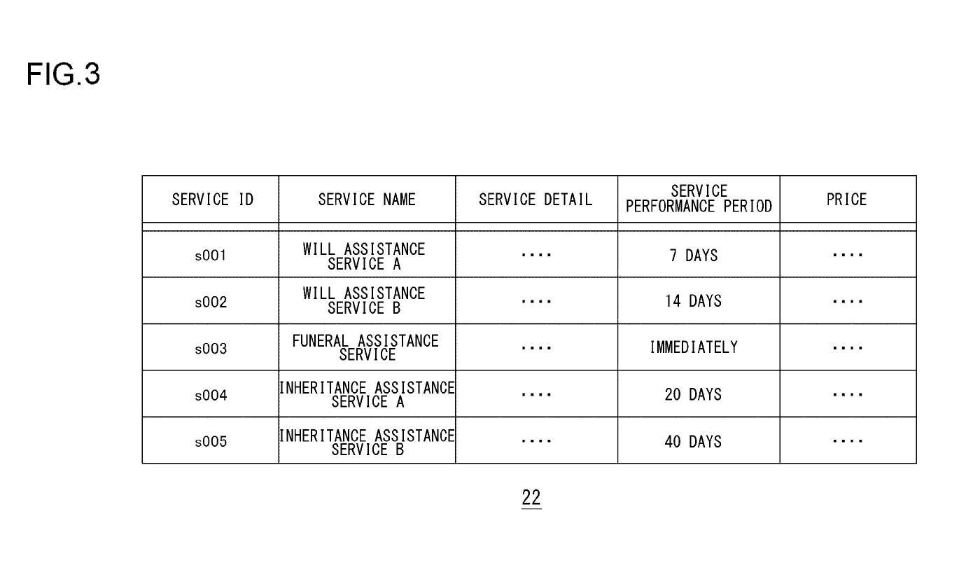

FIG. 3 shows constitution of data stored at service muster 22. Service muster 22 stores, in the form of “service muster information,” respective sets of definition data for a plurality of types of ending services. Service ID(s), service name(s), service description(s), service performance period(s), and price(s) are associated within the service muster information. Of these, service performance period indicates period(s) following death(s) of subscriber(s) which should be allowed to pass before ending service(s) are to be performed. In the embodiment, it is only when the condition that the number of days indicated at the service performance period has elapsed following the death of a subscriber has been met that an ending service is provided to a service recipient. Note that date(s) of death(s) of subscriber(s) for calculation purposes will be taken to be the date(s) of death(s) of the subscriber(s) as given in notification(s) made to service support apparatus(es) 10 by collaborator(s), described below.

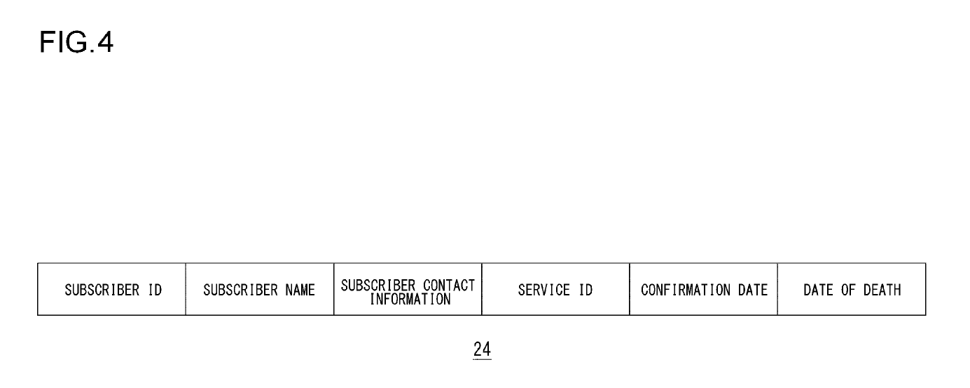

FIG. 4 shows constitution of data stored at subscriber information storage unit 24. Subscriber information storage unit 24 stores, in the form of “subscriber information,” information respectively related to a plurality of subscribers. Subscriber ID(s), subscriber name(s), subscriber contact information, service ID(s), confirmation date(s), and date(s) of death(s) are associated within the subscriber information. Of these, as subscriber contact information, at least email address(es) of subscriber terminal(s) 12 have been entered. And as service ID(s), ID(s) of ending service(s) selected by subscriber(s) from among a plurality of types of ending services presented to subscriber(s) by service support apparatus(es) 10 have been entered. Stating this differently, ID(s) of ending service(s) for the purpose of which a subscriber has subscribed so that the ending service(s) might be provided to service recipient(s) following the subscriber's own death are entered. And as confirmation date(s), the most recent date(s) on which subscriber(s) have been confirmed to be alive by service support apparatus(es) 10 are entered. Furthermore, as date(s) of death(s), date(s) of death(s) of subscriber(s) as confirmed by service support apparatus(es) 10; specifically, date(s) of death(s) of subscriber(s) as given in notification(s) made to service support apparatus(es) 10 by collaborator(s), described below, are entered.

The subscriber ID, subscriber name, and subscriber contact information at FIG. 4 are as of the time of registration of the subscriber at the service vendor, and particular ending service(s) might be entered by default at time(s) when selection thereof has not yet been made. For example, subscriber ID(s), subscriber name(s), and subscriber contact information may be entered manually by the service vendor or might be entered automatically by service support apparatus 10 based on the content of a contract written by the subscriber and concluded with the service vendor. Furthermore, service support apparatus 10 may further comprise subscriber registration unit(s) that accept online registration (signup) of subscriber(s). A subscriber registration unit might provide a page for entry of subscriber information to a terminal (i.e., subscriber terminal 12) of a user, selection of a registration button at that page causing the user to be registered as a subscriber as a result of storage of the subscriber information at subscriber information storage unit 24.

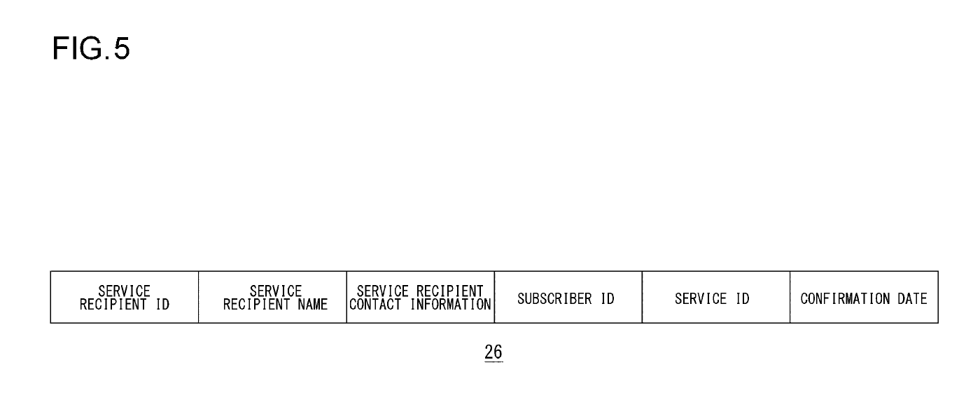

FIG. 5 shows constitution of data stored at service recipient information storage unit 26. Service recipient information storage unit 26 stores, in the form of “service recipient information,” information respectively related to a plurality of service recipients. Service recipient ID(s), service recipient name(s), service recipient contact information, subscriber ID(s), service ID(s), and confirmation date(s) are associated within the service recipient information. Of these, as service recipient contact information, at least email address(es) of service recipient terminal(s) 14 have been entered. And as subscriber ID(s), ID(s) of subscriber(s) who designated service recipient(s) are entered. And as service ID(s), ID(s) of ending service(s) which have been entered by subscriber(s) and which are to be provided to service recipient(s) are entered. And as confirmation date(s), the most recent date(s) on which subscriber(s) have been confirmed to exist by service support apparatus(es) 10 are entered.

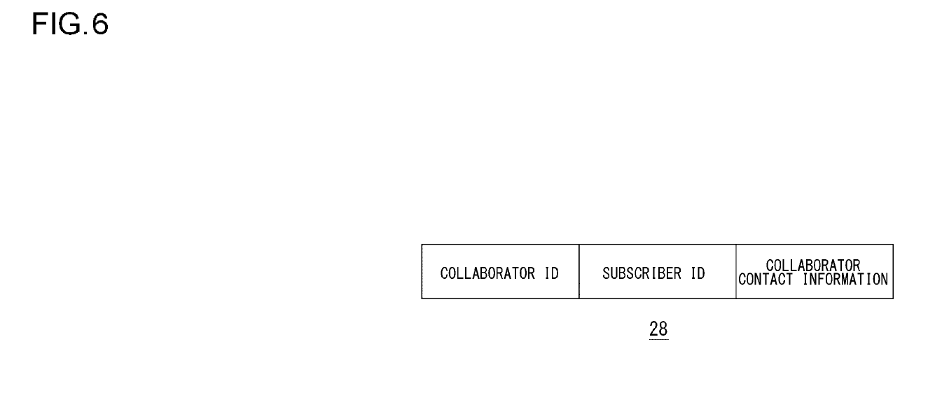

FIG. 6 shows constitution of data stored at collaborator information storage unit 28. Collaborator information storage unit 28 stores, in the form of “collaborator information,” information related to particular service recipient(s) (hereinafter also referred to as “collaborator(s)”) designated in advance by subscriber(s) from among one or more service recipient(s) as user(s) who will collaborate in confirming whether subscriber(s) are alive. As described below, a collaborator is a user who is a service recipient and who also collaborates in confirming whether subscriber(s) are alive. Collaborator ID(s), subscriber ID(s), and collaborator contact information are associated within the collaborator information. Of these, as subscriber ID(s), ID(s) of subscriber(s) who designated collaborator(s) are entered. And as collaborator contact information, at least email address(es) of service recipient terminal(s) 14 of collaborator(s) are entered.

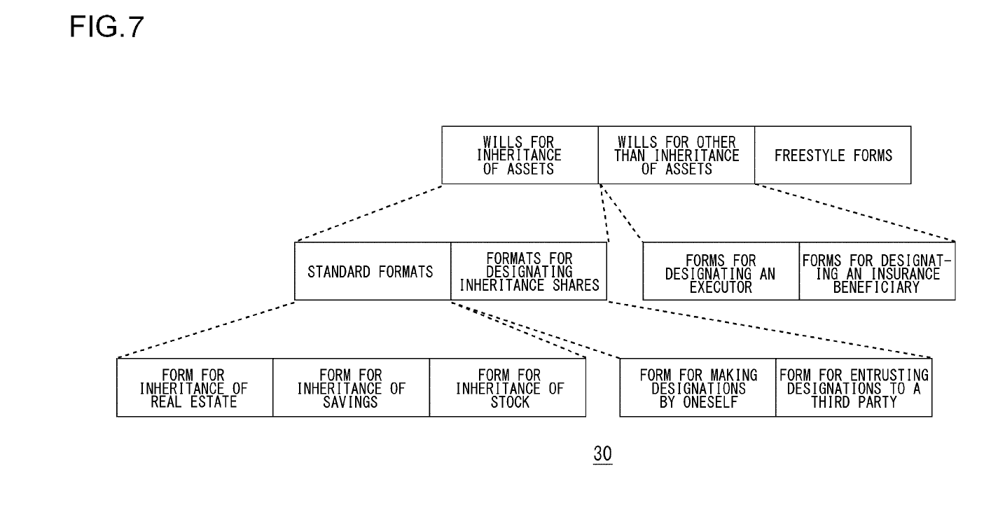

FIG. 7 shows constitution of data stored at document form muster 30. Document form muster 30 stores templates of typical messages which might be sent from subscriber(s) to service recipient(s). In the embodiment, stored therein are a plurality of types of selection items for identifying formats of wills that subscribers might wish to create, and a plurality of types of document forms serving as templates for wills. Furthermore, document form muster 30 stores the plurality of types of selection items and the plurality of types of document forms in such fashion that they are divided into groups in a plurality of hierarchical levels. For example, the top-level category “wills for inheritance of assets” might contain mid-level categories “standard formats” and “formats for designating inheritance shares.” And the mid-level category “standard formats” might contain as will templates a “form for inheritance of real estate,” a “form for inheritance of savings,” and a “form for inheritance of stock.” On the other hand, the mid-level category “formats for designating inheritance shares” might contain as will templates a “form for making designations by oneself” and a “form for entrusting designations to a third party.”

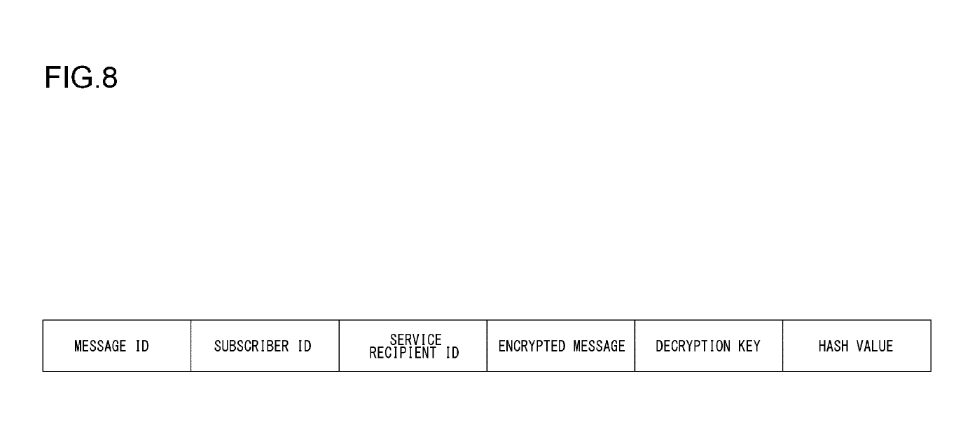

FIG. 8 shows constitution of data stored at message storage unit 32. Message storage unit 32 stores, in the form of “message information,” information related to message(s) to be conveyed from subscriber(s) to service recipient(s). Message ID(s), subscriber ID(s), service recipient ID(s), encrypted message(s), decryption key(s), and hash value(s) are associated within the message information. Of these, as subscriber ID(s), ID(s) of subscriber(s) who created message(s) are entered; and as service recipient ID(s), ID(s) of service recipient(s) who are message addressee(s) are entered. Furthermore, as encrypted message(s), data obtained by encryption of cleartext message(s) from subscriber(s) is entered; and as decryption key(s), key information for decrypting encrypted message(s) is entered. And as hash value(s), hash value(s) generated from cleartext message(s) of subscriber(s) are entered. To improve security, note that service support apparatus 10 does not permanently store in cleartext form the message(s) which were received from subscriber(s).

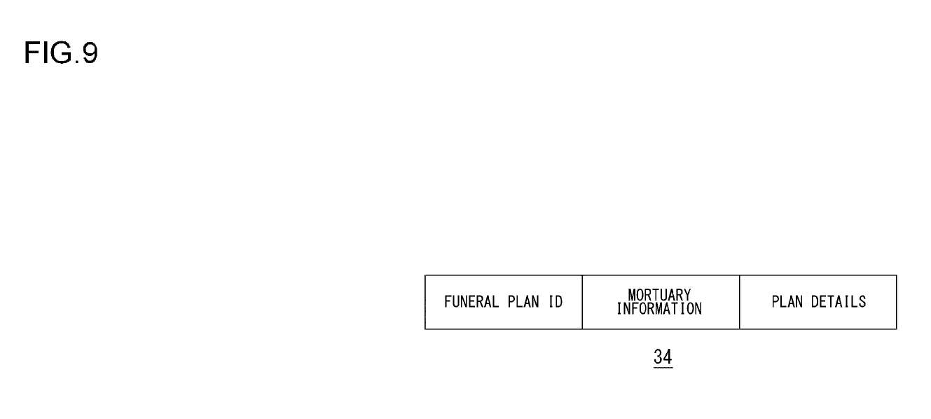

FIG. 9 shows constitution of data stored at funeral plan muster 34. Funeral plan muster 34 stores definition data for funeral plans respectively proposed by a plurality of mortuary vendors, i.e., funeral plans which may be selected by subscriber(s). Funeral plan ID(s), mortuary information, and plan details are associated within this definition data. Of these, as mortuary information, at least contact information for mortuary or mortuaries, e.g., email address(es) of mortuary terminal(s) 16, is entered. Plan details is information indicating detailed content of funeral plan(s), and may for example include funeral scale, funeral hall information, meal content, thank-you present content, funeral price (total price as well as itemized breakdown), and so forth.

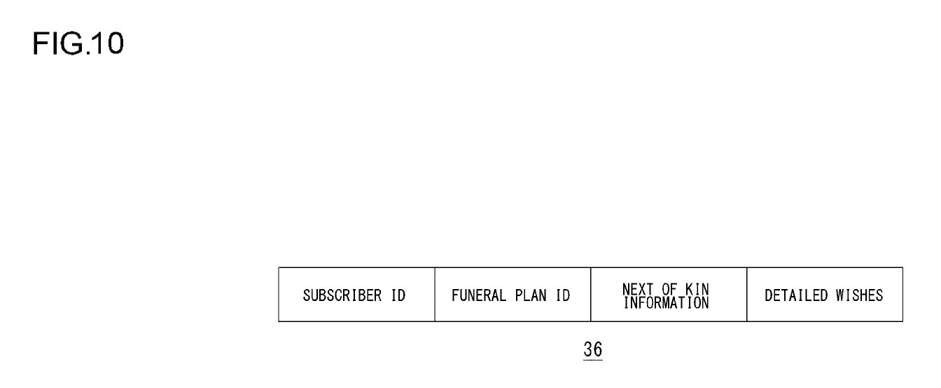

FIG. 10 shows constitution of data stored at funeral information storage unit 36. Funeral information storage unit 36 stores, in the form of “funeral information,” information related to subscriber(s)' own funeral(s) which the subscriber(s) have themselves designed. Subscriber ID(s), funeral plan ID(s), next of kin (surviving family member) information, and funeral details are associated within the funeral information. Of these, as next of kin information, at least contact information for next of kin, e.g., email address(es) of service recipient terminal(s) 14 of next of kin, is entered. Furthermore, funeral details include information regarding desired attendees, designation of religion, information regarding desired posthumous Buddhist name, information regarding desired type of ceremony, desired cemetery, information regarding grave, and so forth.

Returning to FIG. 2, controller 40 comprises service execution unit(s) 42, affected person registration unit(s) 48, subscriber confirmation unit(s) 50, alert unit(s) 52, collaborator confirmation unit(s) 54, service instruction unit(s) 56, service recipient confirmation unit(s) 58, subscriber notification unit(s) 60, and service selection assistance unit(s) 62.

Although not specifically mentioned below, when subscriber terminal 12 accesses service support apparatus 10, service support apparatus 10 requests that subscriber terminal 12 login and requests that a subscriber ID be entered. As a result, service support apparatus 10 is able to know the subscriber ID of the subscriber terminal 12 from which access is being made. Furthermore, although for convenience of description processing is described below as being executed with respect to a single subscriber, processing may in reality be executed sequentially or in parallel with respect to each of a plurality of subscribers.

Service execution unit 42 executes processing related to a plurality of types of ending services; for example, processing for providing ending service(s) which have been designated in advance by a subscriber to service recipient(s) who have been designated in advance by that subscriber. Service execution unit 42 comprises will assistance unit(s) 44 which execute will assistance processing, and funeral assistance unit(s) 46 which execute funeral assistance processing. Detailed description of will assistance unit 44 and funeral assistance unit 46 will be given below.

Note that a portion of the series of processes included among the respective ending services may be executed by service execution unit 42 while the subscriber is still alive. Where this is the case, the remaining process(es), i.e., those process(es) which are to be executed after the death of the subscriber, would be executed upon being so instructed by service instruction unit 56, described below.

Service selection assistance unit 62 provides data for web page(s) (hereinafter also referred to as “service selection page(s)”) which present, to subscriber terminal 12, a plurality of types of ending services that may be executed by service execution unit 42. Put another way, a service selection page is for causing a subscriber to select one or more ending services from among a plurality of types of ending services. More specifically, service selection assistance unit 62 sends to and causes to be displayed at subscriber terminal 12 service selection page(s) on which service muster information stored at service muster 22 is entered in the form of list(s) of ending services.

Furthermore, service selection assistance unit 62 acquires from subscriber terminal 12 information indicating ending service(s) selected by a subscriber at service selection page(s), and stores the service ID(s) thereof in record(s) for the corresponding subscriber at subscriber information storage unit 24. Put another way, the ending service(s) selected by the subscriber are service(s) to be provided after the death of the subscriber in accordance with subscription agreement(s) made between the subscriber and service vendor(s).

For example, among the various public services which include annuities for surviving family members and so forth, and among the various private services which include life insurance and so forth, are those for which procedures should be carried out within a prescribed period following the death of a subscriber. A subscriber who desires that a message be conveyed to a service recipient instructing that procedures should be carried out in order to receive such service(s) would need to select a will assistance service at which a value within the foregoing prescribed period has been entered as the service performance period.

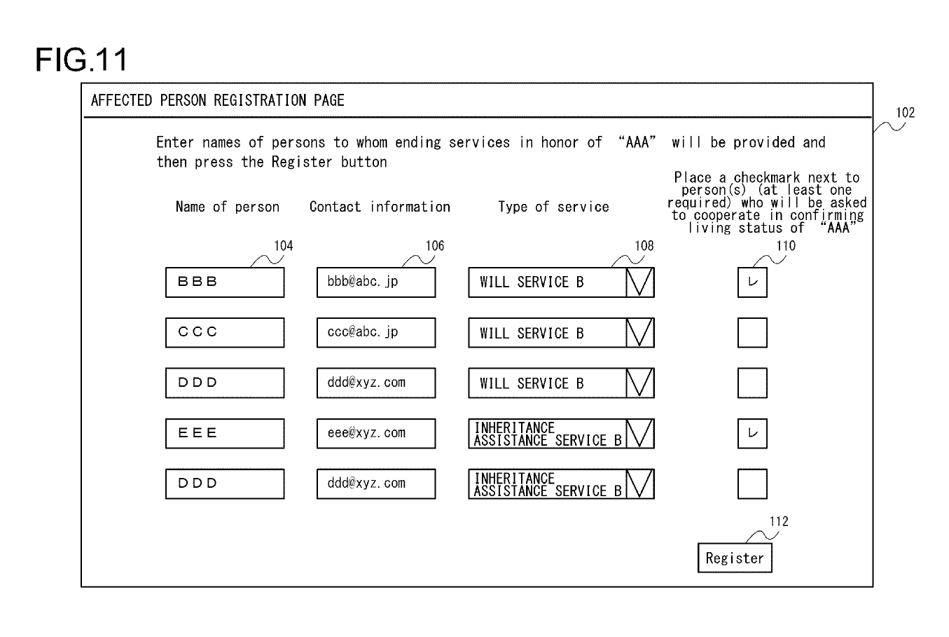

Affected person registration unit 48 sends to and causes to be displayed at subscriber terminal 12 data for web page(s) (hereinafter “affected person registration page(s)”) such as will allow a subscriber to register service recipient(s) and collaborator(s). FIG. 11 shows an example of an affected person registration page. Affected person registration page 102 comprises service recipient name field(s) 104, contact information field(s) 106, service type field(s) 108, collaborator checkbox(es) 110, and registration button(s) 112. Service recipient name field 104 is a field for input of the name of a service recipient, and contact information field 106 is a field for input of contact information of a service recipient, including the email address of service recipient terminal 14.

Service type field 108 is an input field for designating type(s) of ending service(s) to be provided to service recipient(s). Service type field 108 may be a dropdown list permitting selection of particular service(s) from among ending service(s) to which the subscriber is subscribed. Collaborator checkbox 110 is a checkbox for designating that particular service recipient(s) are to be collaborator(s). In the present embodiment, a third party who has nothing to do with an ending service cannot be designated as collaborator, it being necessary that collaborator(s) be selected from among service recipient(s). For example, where a wife, a child, a father, a mother, a friend, a work colleague, and a retained attorney are designated as service recipients, the wife, the child, and the friend might be designated as collaborators.

When registration button 112 at affected person registration page 102 is selected, subscriber terminal 12 sends the service recipient information that was input at affected person registration page 102 to service support apparatus 10. Upon receiving from subscriber terminal 12 the service recipient information that was input at affected person registration page 102, affected person registration unit 48 assigns a unique service recipient ID thereto, and refers to subscriber information storage unit 24 to identify the ID(s) of the ending service(s) that were designated by the subscriber. In addition, the service recipient information is associated with the subscriber ID of subscriber terminal 12 and is stored at service recipient information storage unit 26. Furthermore, for service recipient(s) for which collaborator checkbox(es) 110 were checked, affected person registration unit 48 additionally assigns a unique collaborator ID thereto, and causes the information for those service recipient(s) to also be stored as collaborator information at collaborator information storage unit 28.

Returning to FIG. 2, where collaborator information has been added or updated at collaborator information storage unit 28, collaborator confirmation unit 54 detects this fact. In such case, collaborator confirmation unit 54 sends, to service recipient terminal(s) 14 of collaborator(s) for which collaborator information has been added or updated, electronic mail informing the recipient(s) of their designation as service recipient(s) to whom ending service(s) are to be provided, and of their designation as collaborator(s) who should collaborate in confirming whether the subscriber is alive. That is, user(s) selected as collaborator(s) by the subscriber are informed of that fact and are asked to collaborate in confirming whether the subscriber is alive.

Subscriber confirmation unit 50 periodically sends, to subscriber terminal 12, electronic mail (hereinafter also referred to as “living status confirmation email”) for confirming that the subscriber is alive. A living status confirmation email might for example contain text soliciting reply to service support apparatus 10 in the event that that the subscriber is alive. Upon receipt of a reply to the effect that the subscriber is alive; or more specifically, upon receipt from subscriber terminal 12 of an electronic mail in reply to the living status confirmation email, subscriber confirmation unit 50 causes the confirmation date within the subscriber information at subscriber information storage unit 24 to be updated to the current date. The current date is typically the date of the current time as managed by service support apparatus 10; i.e., it is the so-called system date.

When it is detected that a prescribed waiting period has elapsed following successful confirmation of living status of the subscriber as a result of a living status confirmation email, subscriber confirmation unit 50 again seeks confirmation of the living status of the subscriber. For example, if it is detected that a prescribed number of days has elapsed following the confirmation date within the subscriber information at subscriber information storage unit 24, a new living status confirmation email might be sent to subscriber terminal 12, a reply might be again received from subscriber terminal 12, and the confirmation date at subscriber information storage unit 24 might be again updated. This waiting period can be understood as the periodicity with which living status confirmations are to be repeatedly carried out with respect to a single subscriber, and it can also be understood as the interval between a previous living status confirmation and the next living status confirmation.

The waiting period may be determined as follows. That is, subscriber confirmation unit 50 refers to subscriber information storage unit 24 to identify one or more ending services to which the subscriber is subscribed, and refers to service muster 22 to identify the service performance period(s) defined at each of the ending service(s) to which subscription has been made. In addition, the waiting period is determined in correspondence to the shortest service performance period (hereinafter also referred to as “reference period”) among the service performance period(s) defined at each of the ending service(s) to which subscription has been made. More specifically, the greater the number of days in the reference period the longer will be the waiting period that is set, and the lesser the number of days in the reference period the shorter will be the waiting period that is set. For example, the waiting period might be taken to be a number of days that is 2 or 3 days less than the number of days which is indicated by the reference period. If the subscriber is subscribed to will assistance service B and inheritance assistance service B at FIG. 3, the 14 days defined at will assistance service B might be identified as the reference period, and the waiting period might be determined to be 12 days.

Alert unit 52 determines whether a reply to a living status confirmation email has been received from subscriber terminal 12 within a prescribed period after the living status confirmation email was sent from subscriber confirmation unit 50 to subscriber terminal 12. This prescribed period might be a predetermined grace period for reply which is anywhere from some number of hours to some number of days or the like. Furthermore, alert unit 52 might determine that a reply to the living status confirmation email has not been received by the due date when the date which is the confirmation date stored at subscriber information storage unit 24 plus the reference period becomes equal to the current date. In such case, the grace period for reply would be the difference between the reference period and the waiting period. In the event that it is determined that reply has not been received from subscriber terminal 12 during a prescribed period after a living status confirmation email has been sent, alert unit 52 designates the subscriber ID and instructs collaborator confirmation unit 54 to execute confirmation processing with respect to collaborator(s).

Collaborator confirmation unit 54 refers to collaborator information storage unit 28 to identify collaborator information associated with the subscriber ID designated in the instruction from alert unit 52.

Collaborator confirmation unit 54 sends, to service recipient terminal(s) 14, living status confirmation email(s) for confirming whether the subscriber is alive. These living status confirmation email(s) contain text requesting to be informed of the fact that the subscriber is alive if the subscriber is alive, and requesting to be informed of the date of death of the subscriber if the subscriber is dead.

In the event that content of reply or replies from service recipient terminal(s) 14 of collaborator(s) indicates that the subscriber is alive, collaborator confirmation unit 54 causes the confirmation date within the subscriber information at subscriber information storage unit 24 to be updated to the current date. On the other hand, in the event that content of reply or replies from service recipient terminal(s) 14 of collaborator(s) indicates that the subscriber is dead, i.e., in the event that text corresponding to a date of death of the subscriber is detected within the content of the reply, collaborator confirmation unit 54 causes that date of death to be stored within the subscriber information at subscriber information storage unit 24.

Note that where the subscriber has designated a plurality of collaborators, collaborator confirmation unit 54 sends living status confirmation emails to the respective service recipient terminals 14 of the plurality of collaborators. In addition, collaborator confirmation unit 54 receives replies from the respective service recipient terminals 14 of the plurality of collaborators, and determines whether the subscriber is dead or alive in correspondence to the content of the respective replies. A variety of algorithms may be contemplated for determining whether the subscriber is dead or alive when a plurality of collaborators have been designated. For example, in the event that the content of replies from all collaborators is in agreement, collaborator confirmation unit 54 might make a definitive determination as to whether the subscriber is dead or alive in accordance with the content of those replies. Alternatively, a definitive determination might be made as to whether the subscriber is dead or alive in the event that the content of replies from a majority of the collaborators is in agreement. Furthermore, in the event that the content of replies from the respective collaborators is inconsistent (e.g., where some indicate that the subscriber is alive while others indicate that the subscriber is dead), living status confirmation emails might be sent again to the respective service recipient terminals 14 of the plurality of collaborators.

What algorithm is employed for determining whether the subscriber is dead or alive might be determined as appropriate by the designer in correspondence to the character which it is desired that service support apparatus 10 be made to possess. For example, where priority is to be given to accuracy of determination of whether the subscriber is dead or alive, a definitive determination might be made in the event that the content of replies from all of the collaborators is in agreement. Alternatively, where priority is to be given to speed of determination of whether the subscriber is dead or alive, a determination might be made that the subscriber has died if the content of the reply from at least one collaborator indicates that the subscriber has died. Alternatively, where importance is to be given to both accuracy and speed, a definitive determination might be made as to whether the subscriber is dead or alive in the event that the content of replies from a majority of the collaborators is in agreement.

In the event that a date of death is entered within the subscriber information at subscriber information storage unit 24, service instruction unit 56 identifies service ID(s) stored within the subscriber information at which the date of death is entered, and notifies service execution unit 42 of service execution instruction(s) at which the subscriber ID and service ID(s) are designated. More specifically, for each ending service to which a subscriber whose death has been confirmed is subscribed, determination is made as to whether the date which is the date of death plus the service performance period has been reached. For example, for a particular ending service to which subscription has been made, in the event that it is determined that the current date is equal to the date which is the date of death plus the service performance period for the service in question, service execution unit 42 is instructed to provide the service in question.

Service recipient confirmation unit 58 periodically sends, to service recipient terminal(s) 14, electronic mail for confirming that communication with service recipient(s) is possible; i.e., electronic mail (hereinafter also referred to as “service recipient confirmation email”) for confirming that service recipient(s) are alive and that service recipient information is correct. For example, service recipient confirmation email might be sent once every 6 months to 1 year. When service recipient confirmation unit 58 receives, from service recipient terminal(s) 14, reply or replies that are in response to service recipient confirmation email(s) and that indicate that service recipient confirmation email(s) were properly delivered thereto, the date(s) on which these were received are entered as confirmation date(s) at service recipient information storage unit 26.

Alert unit 52 determines whether reply or replies to service recipient confirmation email(s) have been received from service recipient terminal(s) 14 within a prescribed period (e.g., 1 week or the like) after service recipient confirmation email(s) were sent from service recipient confirmation unit 58 to service recipient terminal(s) 14. In the event that reply or replies are not received within the prescribed period, alert unit 52 designates the subscriber ID and notifies subscriber notification unit 60 of the fact that service recipient information should be updated.

Upon being notified by alert unit 52 that service recipient information should be updated, subscriber notification unit 60 refers to subscriber information storage unit 24 to identify subscriber information associated with the subscriber ID designated by alert unit 52. Subscriber notification unit 60 sends, to subscriber terminal 12 identified in the subscriber contact information, electronic mail indicating that service recipient information should be updated. Upon receiving this electronic mail, the subscriber updates information for service recipient(s) and collaborator(s) at affected person registration screen(s).

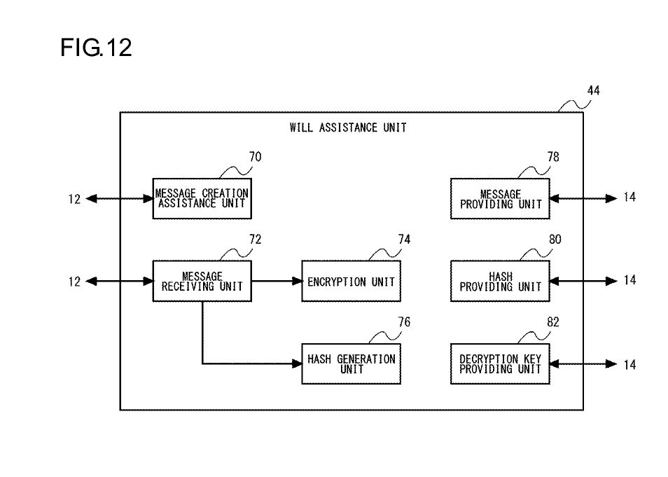

FIG. 12 is a block diagram showing the detailed functional constitution of will assistance unit 44 at FIG. 2. Will assistance unit 44 comprises message creation assistance unit(s) 70, message receiving unit(s) 72, encryption unit(s) 74, hash generation unit(s) 76, message providing unit(s) 78, hash providing unit(s) 80, and decryption key providing unit(s) 82.

Message creation assistance unit 70 provides web page(s) (hereinafter also referred to as “message creation page(s)”) for assisting, by means of an interactive format, subscriber(s) who have selected will assistance service(s) in creating message(s) intended for delivery to service recipient(s). Message creation assistance unit 70 sequentially acquires, from document form muster 30, selection items for identifying type(s) of message(s), and document forms in correspondence to type(s) of message(s) selected by the subscriber. In addition, message creation pages on which such sets of data are entered are sequentially provided to subscriber terminal 12.

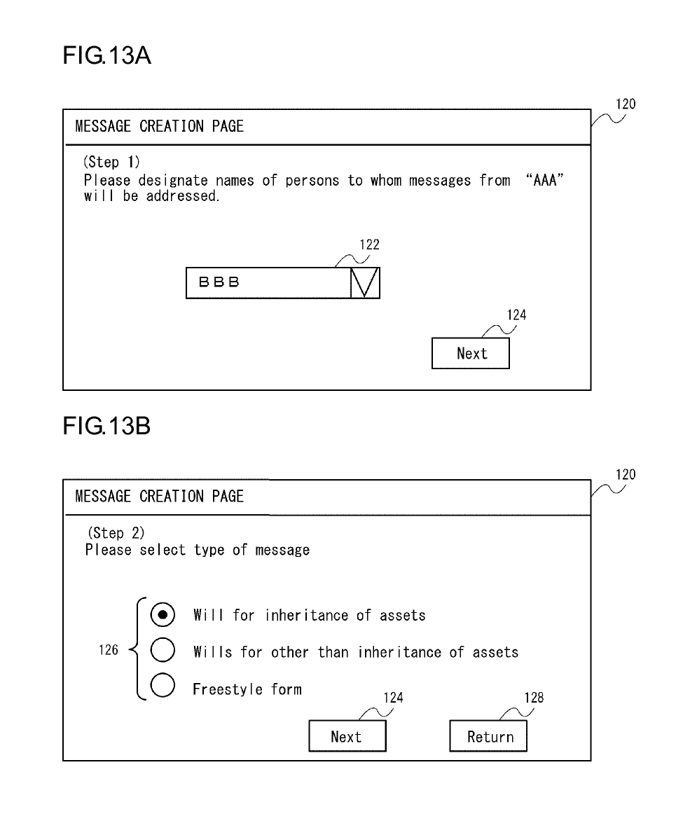

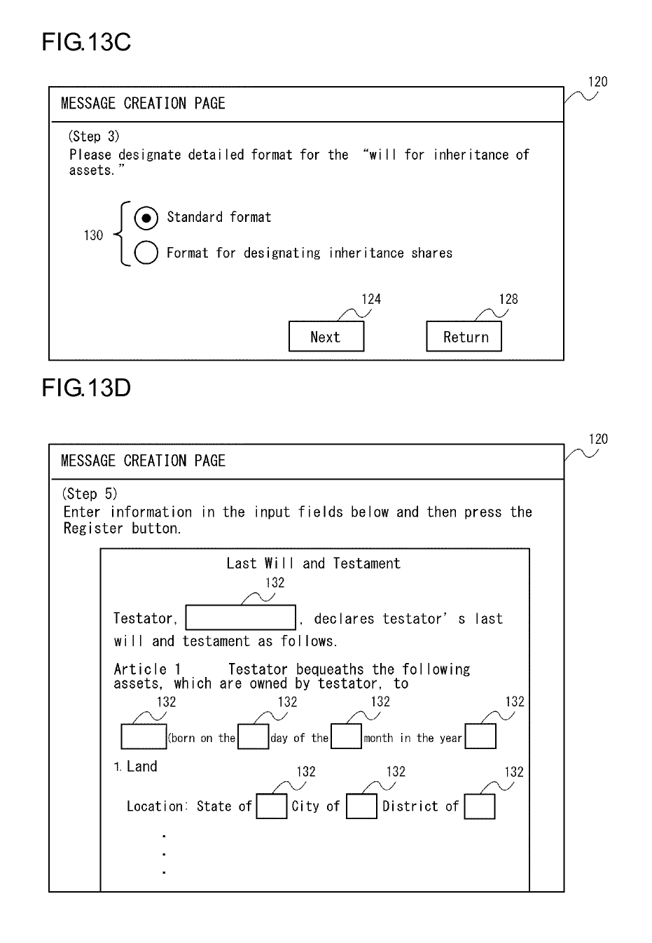

FIG. 13A through FIG. 13D show examples of message creation pages. FIG. 13A shows a message creation page 120 on which, at step 1, message addressee(s), i.e., recipient(s) of will assistance service(s), are designated. Service recipient name field 122 is an input field at which service recipient(s) are designated, and may be a dropdown list permitting selection of particular service recipient(s) from among service recipient(s) which have been previously registered by the subscriber. When the subscriber selects Next button 124, display advances to a message creation page 120 for the next step.

FIG. 13B shows a message creation page 120 on which, at step 2, message type(s) are selected. At radio button 126, message top-level categories at document form muster 30 shown in FIG. 7 are displayed so as to permit selection thereof. If the subscriber selects Next button 124, display advances to a message creation page 120 for the next step; but if the subscriber selects Return button 128, display returns to the message creation page 120 for the previous step.

FIG. 13C shows a message creation page 120 on which, at step 3, message type is selected at a level which is more detailed than at step 2. At radio button 130, message mid-level categories (here, the mid-level categories corresponding to the top-level category “wills for inheritance of assets”) at document form muster 30 shown in FIG. 7 are displayed so as to permit selection thereof. Moreover, at radio button 130, if Next button 124 is selected while “standard formats” is selected, a screen for selection of “form for inheritance of real estate,” “form for inheritance of savings,” and/or “form for inheritance of stock” is displayed as the message creation page at step 4.

FIG. 13D shows a message creation page 120 on which, at step 5, a form for inheritance of real estate is displayed. Displayed at this message creation page 120 is a standard template for a will for use when assets are primarily in the form of real estate. By inputting information into the respective input fields 132, the subscriber is able to create a message in the form of a standard will. When a Register button, not shown, at the message creation page 120 of same drawing is selected, subscriber terminal 12 sends the data which was input into the form for inheritance of real estate and the service recipient information which was designated at step 1 to service support apparatus 10 in the form of message(s) to service recipient(s).

Returning to FIG. 12, message receiving unit 72 receives the message(s) to service recipient(s) that were sent from subscriber terminal 12, and assigns unique message ID(s) thereto. Encryption unit 74 encrypts cleartext message(s) received at message receiving unit 72. In the present embodiment, message(s) are encrypted using the shared key method, encryption unit 74 determining unique data to be used as shared key for each message that is to be encrypted. For example, shared key(s) may be determined based on combination of service recipient ID(s) and date/time information. Encryption unit 74 causes encrypted message data and decryption key(s) (i.e., the foregoing shared key(s)) to be associated with message ID(s), the ID of the subscriber who is the creator of the message(s), and ID(s) of service recipient(s) who are the message addressee(s), and to be stored at message storage unit 32.

Hash generation unit 76 causes cleartext message(s) received at message receiving unit 72 to be input into prescribed hash function(s) such as SHA-1 or the like, and acquires hash value(s) therefrom. Hash generation unit 76 causes message hash value(s) to be associated with the message information created by encryption unit 74 and to be stored at message storage unit 32.

Upon detecting that new encrypted message(s) have been stored at message storage unit 32, message providing unit 78 causes the encrypted message(s) to be provided to recipient(s) of will assistance service(s). More specifically, electronic mail is sent to service recipient terminal(s) 14 identified by ID(s) of service recipient(s) which were designated at message creation page(s), data constituting encrypted message(s) addressed to those service recipient(s) being attached to that electronic mail. Upon detecting that new hash value(s) have been stored at message storage unit 32, hash providing unit 80 causes hash value information to be provided to recipient(s) of will assistance service(s). More specifically, electronic mail is sent to service recipient terminal(s) 14 identified by ID(s) of service recipient(s) which were designated at message creation page(s), data indicating hash value(s) for message(s) addressed to those service recipient(s) being attached to that electronic mail.

Note that encrypted message(s) and hash value data may be sent together in a single electronic mail correspondence.

In the event that it is confirmed at service support apparatus 10 that the subscriber has died; or more specifically, when there is an instruction from service instruction unit 56 that will assistance service(s) are to be provided, decryption key providing unit 82 acquires service recipient ID(s) and decryption key(s) which are associated with the ID of that subscriber from message storage unit 32. Decryption key providing unit 82 sends electronic mail to service recipient terminal(s) 14 identified by service recipient ID(s), decryption key data being attached to that electronic mail. This makes it possible for encrypted message(s) which were previously provided by message providing unit 78 to be decrypted at service recipient terminal(s) 14 so that service recipient(s) can confirm message(s) left by the subscriber.

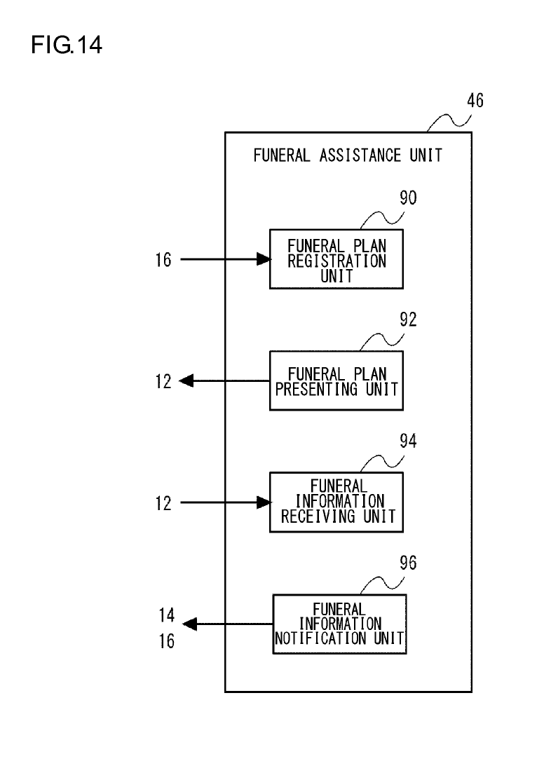

FIG. 14 is a block diagram showing the detailed functional constitution of funeral assistance unit 46 at FIG. 2. Funeral assistance unit 46 comprises funeral plan registration unit(s) 90, funeral plan presenting unit(s) 92, funeral information receiving unit(s) 94, and funeral information notification unit(s) 96.

Funeral plan registration unit 90 receives request(s) to register funeral plan(s) including detailed funeral plan content from mortuary terminal(s) 16, and assigns unique funeral plan ID(s) thereto. In addition, funeral plan ID(s), mortuary information identified based on mortuary terminal(s) 16, and detailed content of funeral plan(s) are associated and are stored at funeral plan muster 34.

Funeral plan presenting unit 92 provides web page(s) (hereinafter also referred to as “funeral assistance page(s)”) for assisting subscriber(s) who have subscribed to funeral assistance service(s) so that the subscriber can himself or herself determine funeral content. More specifically, data for funeral assistance page(s) containing information regarding funeral plan(s) for which registration has been completed at funeral plan muster 34 is sent to and displayed at subscriber terminal 12. Such funeral assistance page(s) include field(s) for selection of funeral plan(s) which are desired by the subscriber, field(s) for input of next of kin information including next of kin contact information, and field(s) for input of funeral details already described with reference to FIG. 10.

Funeral information receiving unit 94 acquires, from subscriber terminal 12, funeral information input at funeral assistance page(s) by the subscriber and stores this at funeral information storage unit 36. As already described with reference to FIG. 10, this funeral information includes funeral plan(s) selected by the subscriber, information regarding next of kin designated by the subscriber, and detailed wishes regarding funeral content (the foregoing funeral details).

Upon detecting that new funeral information has been stored at funeral information storage unit 36, funeral information notification unit 96 causes mortuary terminal(s) 16 of mortuary or mortuaries which proposed funeral plan(s) selected by the subscriber to be notified of funeral information including information regarding the subscriber. Furthermore, funeral information receiving unit 94 also causes service recipient terminal(s) 14 of next of kin designated by the subscriber to be notified of funeral information including information regarding the subscriber. Moreover, in the event that it is confirmed at service support apparatus 10 that the subscriber has died; or more specifically, when there is an instruction from service instruction unit 56 that will assistance service(s) are to be provided, funeral information receiving unit 94 may also cause service recipient terminal(s) 14 of next of kin and mortuary terminal(s) 16 to be notified of funeral information.

Operation of a service support apparatus 10 having the foregoing constitution will now be described.

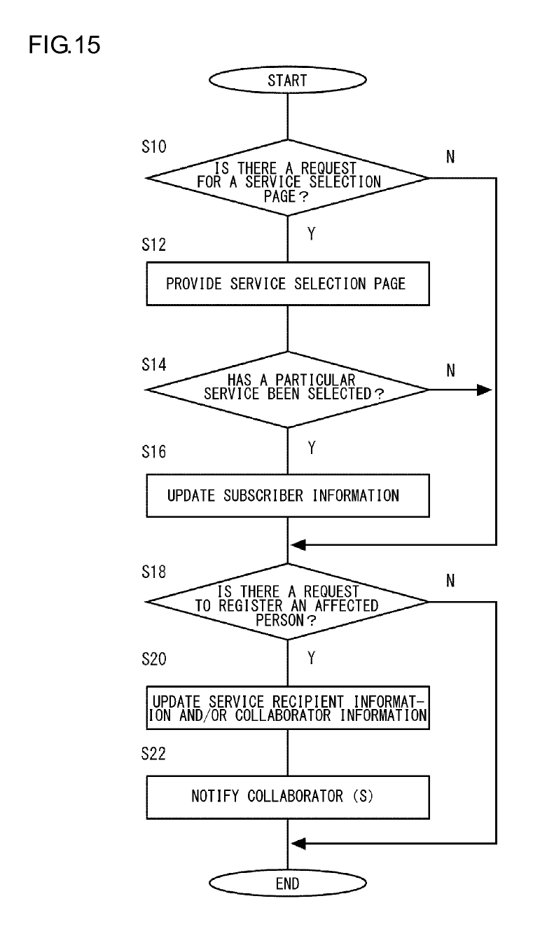

FIG. 15 through FIG. 19 are flowcharts showing operations at service support apparatus 10. FIG. 15 shows operations related to subscription of ending service(s) by the subscriber, and registration of affected person(s) by the subscriber. A user wishing to make preparations in advance for his or her own death; or more specifically, a user wishing while he or she is still alive to design content of event(s) which are to occur after his or her own death, registers his or her own information (i.e., subscriber information) with service vendor(s). This causes this user to gain permission to access service support apparatus 10 as a subscriber by way of subscriber terminal 12.

Upon receiving a request from subscriber terminal 12 to provide information regarding a service capable of being selected by a subscriber (Y at S10), service selection assistance unit 62 provides subscriber terminal 12 with a service selection page that includes service muster information stored at service muster 22 (S12). In the event that designation is made to the effect that particular ending service(s) are being subscribed to at the service selection page (Y at S14), service selection assistance unit 62 causes information regarding the designated ending service(s) to be stored within the subscriber information (S16). This causes ending service(s) which are to be provided to service recipient(s) after the death of the subscriber to be entered therein. In the event that no designation is made to the effect that particular ending service(s) are being subscribed to at the service selection page (N at S14), S16 is skipped; and in the event that no request is received to provide information regarding a service capable of being selected by the subscriber (N at S10), S12 through S16 are skipped.

Upon receiving a request from subscriber terminal 12 to provide an affected person registration page, affected person registration unit 48 provides subscriber terminal 12 with the affected person registration page shown in FIG. 11. At the affected person registration page, for each ending service to which subscription has been made, the subscriber enters information regarding service recipient(s), and moreover designates one or more collaborator by choosing from among the service recipient(s). Upon receiving a request from subscriber terminal 12 to register affected person(s) designated at the affected person registration page (Y at S18), affected person registration unit 48 updates service recipient information at service recipient information storage unit 26 and collaborator information at collaborator information storage unit 28 (S20). In the event that collaborator(s) have been registered, collaborator confirmation unit 54 notifies service recipient terminal(s) 14 of collaborator(s) of the fact that they have been designated as recipient(s) of ending service(s) and as collaborator(s) with respect to whom confirmation of the living status of the subscriber will be carried out (S22). In the event that no request is received to register affected person(s) (N at S18), S20 and S22 are skipped.

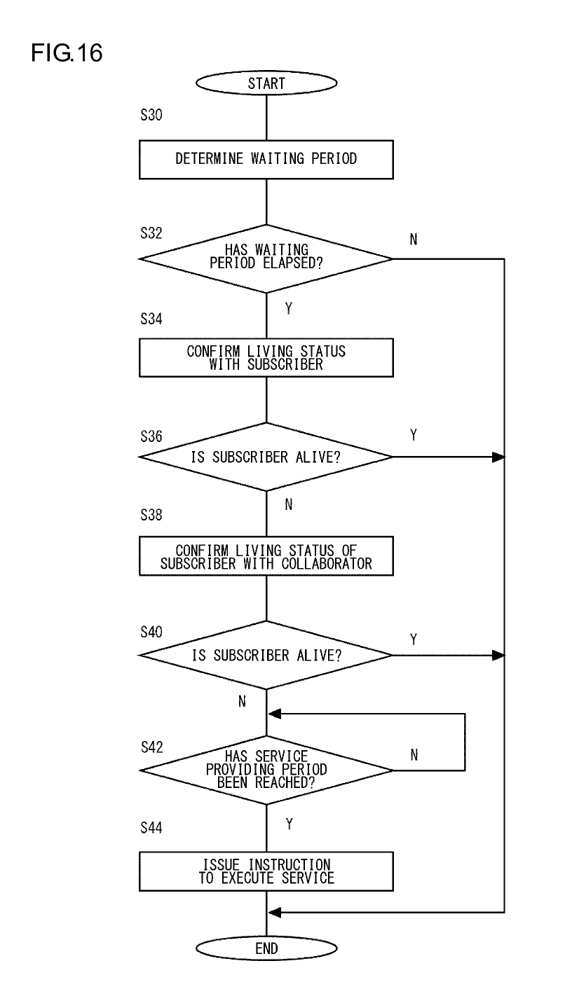

FIG. 16 shows operations related to confirmation of the living status of the subscriber. At same drawing, operations are executed in parallel for each subscriber who has subscribed to ending service(s); i.e., for each record of subscriber information within which one or more service IDs have been entered at subscriber information storage unit 24. Subscriber confirmation unit 50 determines the waiting period for confirmation of living status in correspondence to service performance period(s) defined at ending service(s) to which the subscriber is subscribed (S30). In addition, when it is detected that the waiting period has elapsed following the date in the past on which the living status of the subscriber was confirmed (Y at S32), email for confirming the living status of the subscriber is sent to subscriber terminal 12 (S34). Alert unit 52 makes a determination as to whether the subscriber is alive in correspondence to whether electronic mail has been received from subscriber terminal 12 in reply to the living status confirmation email, and whether reply content is prescribed content that would indicate that the subscriber is alive. In the event that alert unit 52 does not determine that the subscriber is alive (N at S36), collaborator confirmation unit 54 sends email for confirming the living status of the subscriber to service recipient terminal(s) 14 of collaborator(s) (S38).

Collaborator confirmation unit 54 makes a determination as to whether content from service recipient terminal(s) 14 of collaborator(s) in reply to the living status confirmation email indicate that the subscriber is alive or indicate that the subscriber is dead. For example, in the event that the text of reply or replies gives a date of death for the subscriber, a determination might be made that the subscriber has died. In the event that that collaborator confirmation unit 54 determines that the subscriber has died (N at S40), the date of death of the subscriber is stored within the subscriber information at subscriber information storage unit 24. For each ending service to which the subscriber is subscribed, service instruction unit 56 waits until the date defined by the service performance period is reached (N at S42). In addition, when it is detected that the date defined by the service performance period is reached (Y at S42), instruction to execute the ending service is given to service execution unit (S44). In the event that it is confirmed based on reply or replies from collaborator(s) that the subscriber is alive (Y at S40), S42 and S44 are skipped. Furthermore, in the event that it is confirmed based on reply or replies from the subscriber that the subscriber is alive (Y at S36), S38 and following steps are skipped. Furthermore, if the waiting period has not elapsed following the date in the past on which the living status of the subscriber was confirmed (N at S32), S34 and following steps are skipped.

As shown in FIG. 15 and FIG. 16, in accordance with service support apparatus 10 of the embodiment, it is necessary that the collaborator(s) who are to cooperate in confirming the living status of the subscriber be selected from among the service recipient(s) to whom ending service(s) will be provided. Inasmuch as service recipient(s) have some degree of relationship with the subscriber, it is fair to say that they will often be user(s) who are in a position to know the status of the subscriber. By causing collaborator(s) to be chosen from among service recipient(s), it is therefore possible to increase the accuracy with which confirmation of the living status of the subscriber is carried out.

Furthermore, because a collaborator must answer accurately regarding whether or not the subscriber is alive, and because he or she will be a person who carries a certain degree of responsibility with respect to confirmation of the living status of the subscriber, it is possible that a person might not agree to being designated as a collaborator unless there is some benefit to be had from the point of view of the collaborator. At service support apparatus 10, by causing designation of collaborator(s) to be carried out by choosing from among service recipient(s) who will enjoy benefit(s) of service(s), it is possible to make it more likely to obtain cooperation in confirming the living status of the subscriber; i.e., it is possible to provide an incentive that will encourage acceptance of their designation as collaborator. Furthermore, by causing a user who has been designated as a collaborator to be notified of that fact at a time when a collaborator is designated by the subscriber, it is possible to convey to that person in advance the idea that he or she will be expected to collaborate in confirming the living status of the subscriber at some point in the future.

Furthermore, in accordance with service support apparatus 10, the periodicity with which confirmation of the living status of the subscriber is repeatedly carried out (i.e., the foregoing waiting period) is determined in correspondence to service performance period(s) which are observed following the death of the subscriber; i.e., in correspondence to time(s) from the death of the subscriber until service(s) are to be provided to service recipient(s). More specifically, the longer the period(s) from the date of death of the subscriber until service(s) are to be provided to service recipient(s) the longer that this periodicity will be determined to be. This makes it possible to more easily minimize excessive confirmations of the living status of the subscriber, i.e., living status confirmations which might otherwise be carried out at a frequency that would be a burden to the subscriber, while honoring the service performance period(s) for ending service(s) that were presented in advance to the subscriber. Moreover, in the embodiment, in a situation where the subscriber has subscribed to a plurality of ending services, by causing the periodicity to be determined in correspondence to the shortest service performance period among those services, the service performance periods for ending services that were presented in advance to the subscriber are honored.

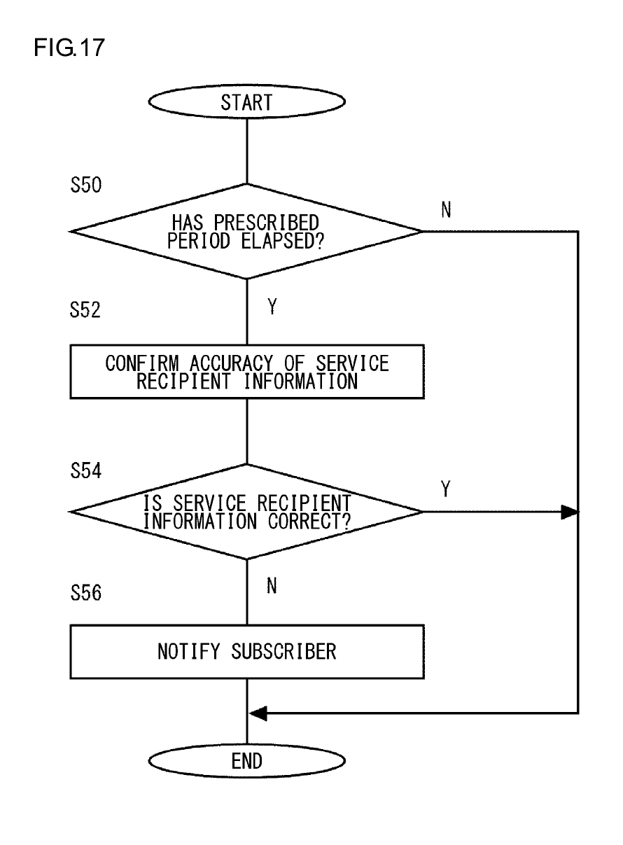

FIG. 17 shows operations related to confirmation of the accuracy of service recipient information. At same drawing, operations are executed in parallel for each service recipient to whom ending service(s) are provided; i.e., for each service recipient information record at service recipient information storage unit 26. When it is detected that a prescribed number of days has elapsed following the date in the past on which the accuracy of service recipient information was confirmed (Y at S50), service recipient confirmation unit 58 sends service recipient confirmation email(s) to service recipient terminal(s) 14 (S52). In the event that alert unit 52 detects that there was no reply from service recipient(s) or that reply content indicates that there is an error in service recipient information (N at S54), subscriber notification unit 60 sends, to subscriber terminal 12, electronic mail indicating that there is an error in the service recipient information and urging that the service recipient information should be updated (S56). In the event that it is confirmed based on reply or replies from service recipient(s) that the service recipient information is correct (Y at S54), S56 is skipped. Furthermore, if the prescribed number of days has not elapsed following the date in the past on which the accuracy of service recipient information was confirmed (N at S50), S52 and following steps are skipped.

As shown in FIG. 17, in accordance with service support apparatus 10 of the embodiment, accuracy of service recipient information is confirmed periodically. Ending services being long-term services, and it being possible for times lasting from several years to several tens of years to occur following subscription by the subscriber before such services are actually provided to service recipient(s), status(es) of service recipient(s) may also change with passage of time. Service support apparatus 10 makes it possible to assist the subscriber in properly reviewing service recipient information so that it reflects the most recent situation, including changes in service recipient contact information and so forth.

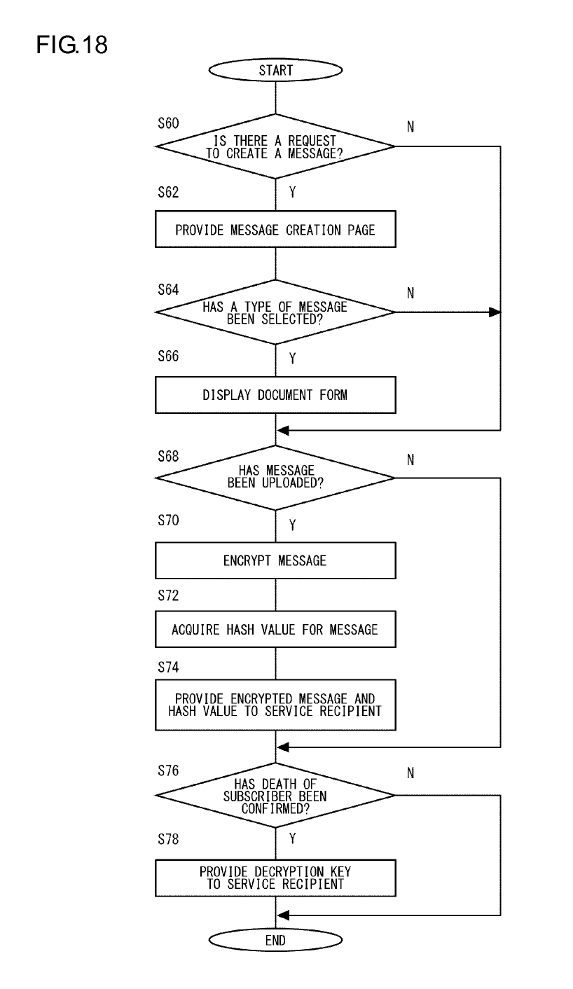

FIG. 18 shows operations related to a will assistance service. Upon receiving a message creation request from subscriber terminal 12 (Y at S60), message creation assistance unit 70 of will assistance unit 44 provides subscriber terminal 12 with a message creation page for assisting in message creation. In the event that the subscriber selects a message type (Y at S64), message creation assistance unit 70 sequentially updates the displayed content of the message creation page in correspondence to the result in correspondence to the result of that selection, ultimately causing the document form which will serve as message template to be displayed (S66). In the event that no message type is selected at the message creation page (N at S64), S66 is skipped; and in the event that no message creation request is received (N at S60), S62 through S66 are skipped. Note that the subscriber may select the freestyle form at FIG. 7 as message type, in which case he or she would be able to freely write whatever he or she wishes to say to service recipient(s) (e.g., last words uttered before death, etc.), without being constrained by the format of an ordinary will. The message from the subscriber may be as simple as, for example, “Thank you for everything; I am ever grateful.”

When message receiving unit 72 receives the message which is uploaded from subscriber terminal 12 (Y at S68), encryption unit 74 encrypts that message (S70), and hash generation unit 76 calculates a hash value for that message (S72). In addition, message providing unit 78 provides the encrypted message to service recipient terminal(s) 14, and hash providing unit 80 provides the hash value data to service recipient terminal(s) 14 (S74). Upon confirmation of the death of the subscriber and issuance by service instruction unit 56 of an instruction to execute the service (Y at S76), decryption key providing unit 82 provides service recipient terminal(s) 14 with key(s) for decryption of encrypted message(s) (S78). In the event that that no message is uploaded from subscriber terminal 12 (N at S68), S70 through S74 are skipped; and in the event that the subscriber is confirmed to be alive (N at S76), S78 is skipped.

As shown in FIG. 18, in accordance with service support apparatus 10 of the embodiment, it only when the condition that the subscriber has died is met that recipient(s) of will assistance service(s) are provided with key(s) for decryption of encrypted message(s). This makes it possible after the death of the subscriber for service recipient(s) to confirm message(s) left by the subscriber. Furthermore, service support apparatus 10 provides service recipient terminal(s) 14 with hash data for the original message from the subscriber. Following decryption of the encrypted message, by comparing hash data generated from the decrypted message and hash data provided by service support apparatus 10, a service recipient can, by confirming that the two are identical, confirm that the message which was decrypted is one that was not subjected to tampering. In other words, it is possible to guarantee that the original message from the subscriber and the message which was provided to the service recipient are identical.

Furthermore, in accordance with service support apparatus 10, by means of an interactive format at a message creation page, the type of will that the subscriber wishes to create is identified, and a document form which matches that type, i.e., a standard will template that has been prepared in advance, is presented to the subscriber. This makes it possible to facilitate creation of a will by the subscriber, and makes it possible to assist in entering information required for it to be an effective will.

Furthermore, in accordance with service support apparatus 10, as the message from the subscriber, it is possible to provide service recipient(s) with a freeform message that is not constrained by the format of an ordinary will. By conveying, to a service recipient, a message that unlike an ordinary will is heartfelt; even where the service recipient is not present at the death of the subscriber, it will nonetheless be possible to provide a circumstance which is equivalent to the opportunity to listen to the last words uttered before death. This makes it possible following the death of the subscriber to assuage the sadness of those who survive him or her.

Furthermore, in accordance with service support apparatus 10, unlike an ordinary will that is widely disclosed to a plurality of affected persons having dealings with the deceased, or that is disclosed to a circle of surviving family members, the subscriber's message(s) are disclosed only to service recipient(s) who are addressee(s) designated by the subscriber. Accordingly, the subscriber can leave a different message to each service recipient, and can ensure that messages to respective service recipients remain secret with respect to persons who are not addressee(s). It is ordinarily the case that there are secrets that a subscriber would wish to disclose to designated service recipient(s) but would like to keep confidential from other persons; such secrets may be entrusted to the present system.

Furthermore, when a person dies suddenly, it may sometimes be the case, for example, that that person's secret stash of money (or “rainy day fund”) is lost without its ever having been discovered by anyone. When service support apparatus 10 is used to leave message(s) in advance which mention such location(s), such problems can be prevented. That is, message(s) from the subscriber which are conveyed to service recipient(s) by service support apparatus 10 include not only those which convey the feelings of the subscriber for the service recipient(s) but also have the capability to convey memoranda along the lines of “what is located where” or “how and what should be done.”

In this regard, whereas the foregoing embodiment was described in terms of an example in which a template for a will was provided to a subscriber, document form muster 30 of service support apparatus 10 may also store list(s) of various types of items (hereinafter also referred to as “reminder items”) which, while being informational items that the subscriber would typically want to keep secret from others while the subscriber is alive but which are items that should be conveyed to service recipient(s) after his or her death, may be assumed to be items that are easily forgotten to be conveyed, such as locations of secret stashes of money or of stock certificates and so forth. In addition, message creation assistance unit 70 may cause display on message creation page(s) of text urging creation of message(s) about reminder items. Furthermore, document form muster 30 may store document format(s) (e.g., templates for conveying secret stashes of money, templates for conveying secret stashes of stock certificates, etc.) for conveying reminder item(s) to service recipient(s), and message creation assistance unit 70 may cause document format(s) to be displayed on message creation page(s) in correspondence to item(s) selected by the subscriber from among reminder items.

Furthermore, although not shown at FIG. 18, message providing unit 78 may receive, from service recipient terminal(s) 14, requests that encrypted message(s) be resent, and encrypted message(s) stored at message storage unit 32 may be resent to service recipient terminal(s) 14. Similarly, hash providing unit 80 may receive, from service recipient terminal(s) 14, requests that hash data be resent, and hash data stored at message storage unit 32 may be resent to service recipient terminal(s) 14. As the services in question are typically services for which the time from registration of a message until disclosure thereof may extend over a long period, it is conceivable that a service recipient might lose an encrypted message or hash data. Message storage unit 32 of service support apparatus 10 may store backup copies of encrypted messages and hash data so as to make it possible to rescue such a service recipient.

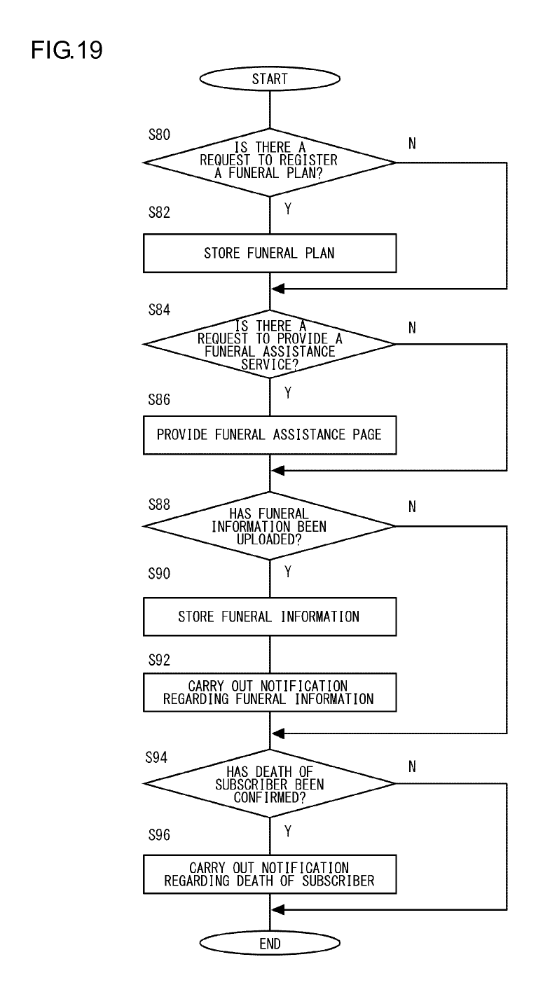

FIG. 19 shows operations related to a funeral assistance service. Upon receiving a request from mortuary terminal 16 to register a funeral plan (Y at S80), funeral plan registration unit 90 of funeral assistance unit 46 stores information about that funeral plan at funeral plan muster 34 (S82). Upon receiving a request from subscriber terminal 12 to provide a funeral assistance service (Y at S84), funeral plan presenting unit 92 provides subscriber terminal 12 with a funeral assistance page for introducing respective funeral plans and for allowing input of the subscriber's wishes regarding his or her own funeral in the form of funeral information (S86). In the event that no request is received to register a funeral plan (N at S80), S82 is skipped; and in the event that no request is received to provide a funeral assistance service (N at S84), S86 is skipped.

Upon receiving the uploaded funeral information from subscriber terminal 12 (Y at S88), funeral information receiving unit 94 stores that funeral information at funeral information storage unit 36 (S90). In addition hereto, funeral information notification unit 96 notifies service recipient terminal(s) 14 of next of kin and mortuary terminal(s) 16 regarding the funeral information (S92). Upon confirmation of the death of the subscriber and issuance by service instruction unit 56 of an instruction to execute the service (Y at S94), funeral information notification unit 96 notifies service recipient terminal(s) 14 of next of kin and mortuary terminal(s) 16 of the fact that the subscriber has died and of the fact that the subscriber's funeral should be performed (S96). In the event that no funeral information is uploaded from subscriber terminal 12 (N at S88), S90 and S92 are skipped; and in the event that the subscriber is confirmed to be alive (N at S94), S96 is skipped.

As shown in FIG. 19, in accordance with service support apparatus 10 of the embodiment, funeral assistance page(s) are provided to the subscriber, and input of the funeral content desired by the subscriber himself or herself is permitted. In addition, mortuary or mortuaries and next of kin are notified of that funeral content. This makes it possible to assist the subscriber in designing his or her own funeral, and to assist by allowing the funeral to be held in a manner that is in accordance with the wishes of the subscriber.

The present invention has been described above in terms of embodiments thereof. Such embodiments being illustrative, it will be understood by one of skill in the art that the respective constituent elements and respective processing operations therein may be combined in manners permitting a wide variety of variations, and that such variations are within the scope of the present invention.

A first variation will now be described. In the foregoing embodiment, subscriber confirmation unit 50 determined the waiting period, which was the periodicity for confirmation of living status, in correspondence to service performance period(s) defined at ending service(s) to which the subscriber was subscribed. Accordingly, by selecting ending service(s), the subscriber indirectly designated the waiting period. In a variation, the subscriber may directly designate the value of the waiting period. More specifically, service support apparatus 10 may further comprise confirmation periodicity acquiring unit(s) that receive information regarding waiting period(s) designated by the subscriber from subscriber terminal(s) 12 and store same within subscriber information at subscriber information storage unit(s) 24. Subscriber confirmation unit(s) 50 would use waiting period(s) acquired by confirmation periodicity acquiring unit(s) as waiting period(s) during processing for confirming the living status of the subscriber. This variation would make it possible for a subscriber to cause time(s) which he or she desires to be entered as periodicity or periodicities for confirming the living status of the subscriber. Moreover, where there is an inconsistency between service performance period(s) at ending service(s) to which the subscriber is subscribed and waiting period(s) designated by the subscriber (e.g., a waiting period is longer than a service performance period, etc.), the confirmation periodicity acquiring unit might cause subscriber terminal 12 to be notified in the form of an alert which advises that there is a possibility that an ending service may not be provided in time to satisfy a service performance period defined at an ending service and which urges the subscriber to revise the waiting period.

A second variation will now be described. In the foregoing embodiment, service recipient confirmation unit 58 sent service recipient confirmation email(s) to respective service recipient(s) which were designated by the subscriber. In a variation, at an affected person registration page, it might be possible for the subscriber to designate service recipient(s) with respect to whom accuracy of service recipient information is to be confirmed periodically (hereinafter also referred to as “first group of service recipient(s)”) and service recipient(s) with respect to whom accuracy of service recipient information is not to be confirmed periodically (hereinafter also referred to as “second group of service recipient(s)”). Affected person registration unit 48 might cause information for distinguishing whether a service recipient is in the first group of service recipient(s) or in the second group of service recipient(s) to be added to service recipient information. Service recipient confirmation unit 58 might cause service recipient confirmation email(s) to be periodically sent to the first group of service recipient(s) but not cause service recipient confirmation email(s) to be sent to the second group of service recipient(s). This variation makes it possible to suppress the sending of service recipient confirmation email(s) to service recipient(s) with respect to whom the subscriber judges it better not to notify of the fact that service(s) will be provided in the future. Moreover, because it is thought that the second group of service recipient(s) might have a less intimate relationship with the subscriber (or be less likely to be aware of the status of the subscriber) than the first group of service recipient(s), designation as collaborator(s) might be limited to member(s) of the first group of service recipient(s). For example, at the affected person registration page, collaborator checkboxes might be displayed in such fashion as to permit checkmarks to be placed therein only for the first group of service recipient(s).

A third variation will now be described. At the will assistance service in the foregoing embodiment, encrypted message(s) and hash data were provided to service recipient terminal(s) 14 when message(s) from the subscriber to service recipient(s) were received. However, the timing with which encrypted message(s) and hash data are provided is not limited thereto. It is sufficient that encrypted message(s) and hash data be provided to service recipient terminal(s) 14 at least by time(s) when decryption key(s) are provided to service recipient terminal(s) 14. For example, in the event that the death of the subscriber has been confirmed and service performance period(s) for will assistance service(s) have been reached, encrypted message(s) and hash data might be provided to service recipient terminal(s) 14 along with decryption key(s).

A fourth variation will now be described. In this variation, encryption of message(s) created by the subscriber for service recipient addressee(s) and acquisition of hash data is carried out at subscriber terminal 12. Will assistance unit 44 of this variation comprises message creation assistance unit(s) 70, decryption key acquisition unit(s), and decryption key providing unit(s) 82. Along with message creation page(s), message creation assistance unit 70 provides subscriber terminal 12 with application(s) that encrypt cleartext message(s) and application(s) that output hash data for cleartext message(s). In addition, at subscriber terminal 12, encryption of message(s) created by the subscriber for service recipient addressee(s), establishment of decryption key(s), and acquisition of hash data are carried out. Furthermore, subscriber terminal 12 uploads decryption key(s) to service support apparatus 10 but sends encrypted message(s) and hash data directly to service recipient terminal(s) 14.

Decryption key acquisition unit(s) acquire decryption key(s) from subscriber terminal 12. In the event that the death of the subscriber has been confirmed and service performance period(s) for will assistance service(s) have been reached, decryption key providing unit 82 sends decryption key(s) to service recipient terminal(s) 14. In accordance with this variation, because the original message(s) of the subscriber are not handled by service support apparatus 10, it is possible to eliminate the possibility that original message(s) are tampered with at service support apparatus 10. Furthermore, by providing decryption key(s) after the death of the subscriber, it is possible after the death of the subscriber for service recipient(s) to confirm message(s) left by the subscriber.

A fifth variation will now be described. In the foregoing embodiment, in the event that reply to living status confirmation email was not received from subscriber terminal 12, alert unit 52 instructed collaborator confirmation unit 54 to carry out confirmation with collaborator(s). In a variation, in the event that reply to living status confirmation email was not received from subscriber terminal 12, alert unit 52 might send message(s) to operator(s) of service support apparatus 10 (e.g., person(s) responsible for service vendor(s)) indicating that confirmation with collaborator(s) should be carried out. Furthermore, in the foregoing embodiment, in the event that the death of the subscriber is confirmed, service instruction unit 56 instructed service execution unit 42 to provide ending service(s). In a variation, operator(s) of service support apparatus 10 might be notified in the form of message(s) indicating that operations for provision of ending service(s) should be performed. Upon receiving such messages, the operator might carry out operations at service support apparatus 10 so as to cause execution of processing for confirmation with respect to collaborator(s) and processing for provision of ending service(s).

A sixth variation will now be described. The service support apparatus 10 of this variation provides message(s) from the subscriber in correspondence to birthday(s) of service recipient(s) and/or or other such event(s) in the life or lives of service recipient(s). More specifically, will assistance unit 44 is not limited to wills but functions as processing unit for distributing generic messages. Message creation assistance unit 70 is such that further provided on message creation page(s) there are input field(s) for allowing the subscriber to designate date(s) on which message(s) are to be distributed. Message storage unit 32 also stores message distribution date(s) as message information, and message receiving unit 72 causes distribution date(s) designated at message creation page(s) to be stored at message storage unit 32. For each message stored at message storage unit 32, service instruction unit 56 determines whether the distribution date thereof is equal to the current date, and in the event that it is determined that there is a message for which the distribution date is equal to the current date, service instruction unit 56 instructs will assistance unit 44 to provide that message.

As mode of providing message(s) in the present variation, encrypted message(s) may be provided to service recipient terminal(s) 14 in advance prior to distribution date(s), with decryption key(s) being provided to service recipient terminal(s) 14 in correspondence to instruction(s) from service instruction unit 56, as was the case in the embodiment. Furthermore, encrypted message(s) and decryption key(s) may both be provided at the same time to service recipient terminal(s) 14 in correspondence to instruction(s) from service instruction unit 56. Moreover, cleartext message(s) obtained by decryption from encrypted message(s) may be provided to service recipient terminal(s) 14 in correspondence to instruction(s) from service instruction unit 56. With respect to the timing with which hash data is provided as well, this may be provided to service recipient terminal(s) 14 in advance prior to distribution date(s), and/or may be provided to service recipient terminal(s) 14 in correspondence to instruction(s) from service instruction unit 56. This variation makes it possible for message(s) created by the subscriber for service recipient addressee(s) to be provided to service recipient(s) at any timing(s) desired by the subscriber.

A seventh variation will now be described. The service support apparatus 10 of this variation provides functionality to effectively prompt the subscriber to update message(s). More specifically, message storage unit 32 also stores date(s) when message(s) are updated. Alert unit 52 refers to date(s) of update(s) of respective message(s) stored at message storage unit 32, and if a message (hereinafter also referred to as “unupdated message”) that has not been updated for a prescribed time (e.g., one year) is detected, alert unit 52 instructs subscriber notification unit 60 to prompt the subscriber to update the unupdated message. Subscriber notification unit 60 sends, to subscriber terminal 12, electronic mail urging that the unupdated message be updated. This electronic mail may contain text which includes, for example, service recipient(s) (message addressee(s)); content of the unupdated message; and date of update (the date that the unupdated message was registered). As it is supposed that the message(s) which a subscriber would like to leave for service recipient(s) might change with passage of time, this variation facilitates provision of the most recent thoughts of the subscriber to service recipient(s).

Moreover, where it is detected that there are a plurality of unupdated messages for a single subscriber, to avoid concentrating updating procedures together, it is desirable that prompting of updating by subscriber notification unit 60 be carried out in accordance with an algorithm designed to reduce the burden on the subscriber by causing procedures to be carried out in distributed fashion. For example, after sending electronic mail urging that one unupdated message be updated, a prescribed period (e.g., one week) might be allowed to elapse before electronic mail is sent urging that another unupdated message be updated. Furthermore, for example, where it is detected that there are a plurality of unupdated messages for a single subscriber, alert unit 52 might instruct subscriber notification unit 60 to urge that one unupdated message thereamong be updated. This will make it possible to avoid placing a large burden (high stress) on the subscriber for the sake of updating of message(s), and will make it possible to prevent obsolescence of message(s).

An eighth variation will now be described. The service support apparatus 10 of this variation provides functionality for changing way(s) in which message(s) are sent in correspondence to message accessing environment(s) of service recipient(s). Note that as used herein, the term “accessing” should where appropriate be understood to include one or more of “viewing,” “listening,” “browsing,” “rendering,” “rendition,” “playback,” and so forth. More specifically, message providing unit 78 further comprises conversion unit(s) that decrypt encrypted message(s) in correspondence to notification (e.g., notification via electronic mail or web page) from service recipient(s). This notification indicates message accessing environment(s) at service recipient terminal(s) 14, and might, for example, be information indicating whether decryption capability is present, information identifying type(s) of terminal(s), or information designating that message(s) are to be provided in cleartext form or that message(s) are to be provided in audio form. In accordance with the content of notification(s) from service recipient(s), conversion unit(s) decrypt encrypted message(s) addressed to such service recipient(s), and/or convert content of the post-decryption message(s) to audio data. Where encrypted message(s) have been converted by conversion unit(s), message providing unit 78 sends the post-conversion data (cleartext message(s) and/or audio data) to service recipient terminal(s) 14; and where encrypted message(s) remain unconverted by conversion unit(s), message providing unit 78 sends the encrypted message(s) to service recipient terminal(s) 14. This variation makes message(s) from the subscriber to be definitively conveyed to service recipient(s).

A ninth variation will now be described. The service support apparatus 10 of this variation provides functionality for suppressing confirmation of the living status of the subscriber. More specifically, subscriber information storage unit 24 also stores living status confirmation suppression period(s) serving as period(s) during which confirmation of the living status of the subscriber is to be stopped. Subscriber confirmation unit 50 receives in advance from subscriber terminal 12 information indicating period(s) (e.g., from October 1 to October 20, etc.) during which the subscriber will be unable to respond to living status confirmation emails due to travel, hospital admission, or the like, and stores such period(s) as living status confirmation suppression period(s) at subscriber information storage unit 24. If the current date falls within a living status confirmation suppression period for a particular subscriber, even if it is detected that the waiting period has elapsed following the date in the past on which living status was confirmed, subscriber confirmation unit 50 is stopped from sending living status confirmation email to that subscriber. This variation makes it possible to suppress the carrying out of living status confirmation when it is known in advance that the subscriber will be unable to respond to living status confirmation emails due to travel, hospital admission, or the like. This makes it possible to avoid the unnecessary trouble and confusion that would otherwise occur were what would eventually prove to be an unnecessary dead status confirmation email to be sent to collaborator(s).

A tenth variation will now be described. In this variation, instead of allowing the subscriber to designate collaborator(s), the system automatically selects collaborators. Here, persons chosen by subscribers to be collaborators are usually family members, close friends, or other with whom the subscriber has an intimate relationship. Whether there is an intimate relationship can be inferred from the frequency with which messages are updated and/or the content of messages. Message storage unit 32 therefore also stores information indicating message update frequency; e.g., the number of updates or the time between updates. Controller 40 further comprises a collaborator selection unit(s) that select collaborator(s) from among a plurality of service recipients and enter this at collaborator information storage unit 28 based on the frequency with which a plurality of messages entered by a particular subscriber for a plurality of service recipients are updated and/or content of the respective messages.

For a single subscriber, collaborator selection unit(s) might select as collaborator(s) those service recipient(s) with respect to whom the frequency with which message(s) are updated is higher than the average update frequency of message(s) registered by that subscriber. For example, service recipient(s) for whom message(s) are updated more times than the average number of updates might be selected as collaborator(s), or service recipient(s) for whom the time between message updates is shorter than the average time between updates might be selected as collaborator(s). Furthermore, collaborator selection unit(s) might select as collaborator(s) those service recipient(s) with respect to whom it may be inferred that message(s) are of greater importance than other message(s). For example, message(s) created using document form(s) in the wills for inheritance of assets category might be detected from among a plurality of messages, and service recipient(s) of those message(s) might be selected as collaborator(s).

An eleventh variation will now be described. Whereas in the foregoing embodiment the message(s) registered by the subscriber were uniformly encrypted, the service support apparatus 10 of the present variation causes security level of message(s) to be varied independently in correspondence to message content. More specifically, high importance or low importance is associated in advance with each of the plurality of document forms stored at document form muster 30. For example, the respective document forms in the wills for inheritance of assets category might be associated with high importance, and other document forms might be associated with low importance.

Encryption unit 74 might cause message(s) created using document form(s) having high importance to be encrypted in the same manner as at the embodiment, but might cause message(s) created using document form(s) having low importance to be stored as unencrypted cleartext at message storage unit 32. Where encrypted message(s) are stored at message storage unit 32, message providing unit 78 causes the encrypted message(s) to be immediately provided to service recipient terminal(s) 14 in the same manner as in the embodiment. On the other hand, where cleartext message(s) are stored at message storage unit 32, at a time when the death of the subscriber is detected, i.e., when notification regarding the death of the subscriber is received from service instruction unit 56, the cleartext message(s) are provided to service recipient terminal(s) 14. Because message(s) having low importance are provided to service recipient terminal(s) 14 in unencrypted cleartext form, this variation eliminates the need for decryption processing at service recipient terminal(s) 14, and makes it possible for service recipient(s) to conveniently confirm message content.

In accordance with another example, encryption unit 74 might determine importance of message(s) based on keyword search. For example, prescribed keyword(s) presumed to be contained in messages having high importance (“account number,” “cash,” “inheritance,” etc.) or regular expressions or other such character string patterns might be stored in advance, message(s) containing such keyword(s) might be determined to be message(s) having high importance, and message(s) not containing such keyword(s) might be determined to be message(s) having low importance. Moreover, in the foregoing variation, information for distinguishing document form(s) selected by the subscriber at time(s) of message creation may be conveyed by notification from subscriber terminal 12 to service support apparatus 10 at time(s) when message(s) are registered, and service support apparatus 10 may determine importance of message(s) based on this notification.

A twelfth variation will now be described. At service support apparatus 10 in accordance with the foregoing embodiment, encrypted message(s) and hash data were permanently in the form of backup copies so as to permit resending thereof in the event that a service recipient lost an encrypted message or hash data. In a variation, once service recipient(s) have been provided with encrypted message(s) and hash data, message storage unit 32 might thereafter not store such data but might store only decryption key(s). For example, after providing encrypted message(s) to service recipient terminal(s) 14, message providing unit 78 might delete encrypted message(s) from message storage unit 32. Similarly, after providing hash data to service recipient terminal(s) 14, hash providing unit 80 might delete hash data from message storage unit 32. This variation makes it possible to still more definitively prevent divulgence to third parties of encrypted message(s) and/or hash data.

Note that any arbitrary combination of the aforementioned embodiments and variations may also be effectively employed as an embodiment of the present invention. New embodiments arising from such combinations will exhibit the various respective benefits of the embodiments and variations of which they are composed.

One of skill in the art will also appreciate that the functions displayed by the respective elements recited in the claims may be implemented by the respective elements indicated in the embodiments and variations either alone or in cooperation therewith.

What is claimed is:

1. A service support apparatus for providing a service, when a subscriber has died, to recipients registered in advance by the subscriber, the service support apparatus comprising:
an instruction unit, which, when confirmation is received from a collaborator registered in advance by the subscriber that the subscriber has died, issues an instruction to provide the service; and
a registration unit at which the service recipients and the collaborator are registered,
wherein the registration unit is constituted so as to display the service recipients on an information terminal so that the collaborator can be registered by choosing from among the displayed service recipients.
wherein the registration unit is constituted so as to permit the collaborator to be registered by choosing from among the service recipients.

2. The service support apparatus according to claim 1, further comprising a collaborator notification unit, which notifies a collaborator registered at the registration unit that an individual has been registered as a service recipient who will be provided with a service, and has further been registered as a collaborator who should cooperate in confirmation of living status of the subscriber.

3. The service support apparatus according to claim 1, further comprising:
a service recipient confirmation unit, which notifies a service recipient, in the form of a message, that the service recipient will be provided with a service, and which receives from the service recipient a reply to that message; and
a subscriber notification unit, which, in the event that reply is not received from the service recipient, notifies the subscriber, in the form of a message, to request that the service recipient be updated.

4. The service support apparatus according to claim 1, further comprising:
a funeral plan presenting unit, which presents the subscriber with a plurality of funeral plans, and which allows the subscriber to select a funeral plan for use in the event that the subscriber dies; and
a funeral plan notification unit, which notifies a designated person affected by the funeral of the subscriber of information indicating a funeral plan selected by the subscriber.
